(19) United States
(12) Patent Application Publication
(10) Pub. No.: US 2026/0255113 A1
(43) Pub. Date: Aug. 27, 2026

(54) Receiver Module and Arrangement

(71) Applicant: SONOVA AG, Staefa (CH)

(72) Inventors: Andre Ochsenbein, Wolfhausen (CH); Daniel Probst, Uerikon (CH)

(21) Appl. No.: 19/461,398

(22) Filed: Jan. 27, 2026

(30) Foreign Application Priority Data
Jan. 30, 2025 (EP) 25154921.8

(51) Int. Cl. H04R 25/00

(52) U.S. Cl. CPC H04R 25/604; H04R 25/652; H04R 2225/025

(57) ABSTRACT

Described herein are a receiver module configured to be inserted into an ear canal of a user, the receiver module comprising a housing containing a speaker configured to reproduce sound into the ear canal through a sound port arranged at an end of the housing in a longitudinal direction, the end of the housing having the sound port comprising an adapter or being formed as an adapter configured to releasably couple to a spout.

### RELATED APPLICATIONS

The present application claims priority to EP Patent Application No. 25154921.8, filed January 30, 2025, which is hereby incorporated by reference in its entirety.

### BACKGROUND INFORMATION

The human ear canal exhibits significant variability among individuals in terms of size, shape, and curvature. This diversity can be attributed to genetic factors, age, and even environmental influences.

Some key points to describe this variability include:
Size: Ear canals can vary widely in diameter and length, affecting how sound travels and how hearing aids fit.
Shape: The ear canal can be straight, curved, or have multiple bends, influencing the ease of inserting hearing aids and the comfort of the user.
Curvature: The degree of curvature can differ, impacting the acoustic properties and the design considerations for hearing aids.
Texture and Sensitivity: The skin lining the ear canal can vary in thickness and sensitivity, which is crucial for ensuring comfort and preventing irritation from hearing aids.

Understanding these variations is essential for the customization and effective fitting of hearing aids, ensuring optimal performance and user comfort.

Acoustical coupling of a receiver in canal hearing device (RIC) or an in the ear hearing device (ITE) to the ear canal is achieved using a dome. The dome realizes the connection to the ear canal. The receiver and the connection is designed to allow the dome to be exchanged. The receiver has a sound exit on a side to which the dome is connected. A cable with a connector connects a behind the ear part (BTE) to the RIC.

Fitting a standard dome to the anatomy of an ear can present several challenges due to the unique and variable nature of each individual's ear canal. Some of the primary difficulties are:
size mismatch: Standard domes come in a limited range of sizes, which may not perfectly match the diameter of every ear canal. A dome that is too large can cause discomfort or pain, while one that is too small may not provide a secure fit, leading to feedback or poor sound quality.
shape and curvature: The ear canal's shape and curvature can vary significantly. A standard dome may not conform well to a highly curved or irregularly shaped ear canal, resulting in poor acoustic seal and reduced effectiveness of the hearing aid.
comfort and irritation: The skin inside the ear canal is sensitive. A dome can cause irritation, soreness, or even abrasions, leading to discomfort and potential reluctance to use the hearing aid consistently.
retention issues: If the dome does not fit securely, it can easily become dislodged, especially during activities like talking, chewing, or moving. This can be frustrating for the user and may require frequent adjustments.
acoustic performance: An improper fit can lead to acoustic leakage, which can cause feedback (whistling sounds) and reduce the overall effectiveness of the hearing aid. It can also affect the amplification and clarity of sounds.
earwax and moisture: Earwax buildup and moisture can affect the fit and performance of the dome. A standard dome may not accommodate these factors well, leading to blockages or reduced sound quality.

The cable and connection mechanism may also be used in a custom earpiece specially made for a RIC or an ITE. These custom earpieces also need a separate connector part for the connection between the receiver and the custom earpiece, e.g. a soft tube.

### SUMMARY

Described herein is a novel receiver module and a novel receiver arrangement.

In some examples, a receiver module configured to be inserted into an ear canal of a user is provided, the receiver module comprising a housing, e.g. an elongate housing, containing a speaker configured to reproduce sound into the ear canal through a sound port arranged at an end of the housing in a longitudinal direction, the end of the housing having the sound port comprising an adapter or being formed as an adapter configured to releasably couple to a spout.

The receiver module may be part of a hearing instrument such a hearing device, e.g. a receiver in canal (RIC) hearing device or an in the canal (ITE) hearing device, or an earbud.

The speaker may for example be a balanced armature receiver.

The adapter allows for replacing the spout by a different one, e.g. having a different size and/or shape. The solution according to the features described herein may improve adjustment of the receiver to fit the anatomy of the user’s ear canal and keep the diameter of the coupling between the housing and the spout small. Moreover, the retention of the receiver in the ear canal may be improved, e.g. by the dome or custom ear piece being allowed to tilt relative to the longitudinal axis of the receiver and engage behind a bend in the ear canal, in particular if the ear canal tapers. The solution according to the features described herein may also improve or facilitate the centering of the dome or custom ear piece in the ear canal to improve sealing and/or reduce irritation and thus improve wearing comfort. Moreover, the pickup of cerumen may be reduced.

In an exemplary embodiment, the adapter is part of the housing or fixed to the housing, e.g. by gluing.

According to an aspect, a receiver arrangement is proposed, comprising the receiver module as described above and a spout, wherein the adapter comprises a holding structure and the spout comprises a complementary structure configured to engage with the holding structure.

In an exemplary embodiment, the holding structure has a shoulder allowing insertion of the complementary structure of the spout in an insertion direction transverse or perpendicular to the longitudinal direction into the holding structure so that the complementary structure engages the holding structure behind the shoulder preventing the spout from being removed from the adapter in the longitudinal direction.

In an exemplary embodiment, the holding structure and the complementary structure may comprise an elliptical or a semi-elliptical, in particular a semi-circular cross section. This has the advantage, that, when the spout is coupled to the housing, the overall space of the holding structure and the complementary structure is particularly small because the receiver module conforms to the elliptical shape of an ear canal and can easily be inserted in a majority of ear canals.

In an exemplary embodiment, the adapter comprises a locking bar movable in a locking direction transverse or perpendicular to both the longitudinal direction and the insertion direction within the holding structure, between an unlocked position allowing insertion and removal of the complementary structure and a locked position, in which the locking bar engages the locking structure in such a way that the complementary structure is prevented from being removed from the holding structure.

In an exemplary embodiment, the spout comprises a circumferential shoulder for engaging an internal circumferential notch in a dome configured to seal against the ear canal. The dome may be a universal part suitable for a multitude of users.

In an exemplary embodiment, the spout is at least essentially straight or angled with respect to the longitudinal direction when attached to the housing.

In an exemplary embodiment, the holding structure is shaped as a spherical or spheroid head, wherein the complementary structure is shaped complementary to the spherical or spheroid head of the holding structure on the inside and slightly larger than the holding structure to allow the holding structure to engage in the complementary structure by friction and/or by a snap fit and/or by a threaded engagement.

In an exemplary embodiment, the complementary structure is shaped as a spherical or spheroid head, wherein the holding structure is shaped complementary to the spherical or spheroid head of the complementary structure on the inside and slightly larger than the complementary structure to allow the complementary structure to engage in the holding structure by friction and/or by a snap fit and/or by a threaded engagement.

The frictional engagement may be such that an angle of the adapter relative to the receiver module can be adjusted using a tool, e.g. by a hearing care professional, but will maintain the set angle under the circumstances of normal use.

In an exemplary embodiment, the holding structure and/or the complementary structure have/has one or more longitudinal slots respectively, so as to allow the holding structure and/or the complementary structure to be elastically collapsed or expanded to some extent.

In an exemplary embodiment, the adapter and/or the spout consists of or comprises a metal and/or a plastic.

In an exemplary embodiment, the spout comprises a flexible tube attached at one end to the complementary structure or comprising the complementary structure at one end.

In an exemplary embodiment, the flexible tube at its other end is configured to be coupled to an ear tip. The ear tip may be a custom ear tip or shell shaped to fit the ear canal of a specific user.

Further scope of applicability of the present invention will become apparent from the detailed description given hereinafter. However, it should be understood that the detailed description and specific examples, while indicating embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitative of the present invention, and wherein:

FIG. 1 a schematic view of a receiver arrangement, comprising a receiver module having an adapter for coupling to a spout,

FIG. 2 another schematic view of the embodiment of the receiver module and adapter of FIG. 1, with a locking bar in an unlocked position,

FIG. 3 another schematic view of the embodiment of the receiver module and adapter of FIG. 1, with the locking bar in a locked position,

FIG. 4 a schematic view of an embodiment of the receiver arrangement with the spout being angled with respect to a longitudinal direction,

FIG. 5 a schematic view of another embodiment of the receiver arrangement,

FIG. 6 a schematic view of a dome configured to seal against an ear canal of a user,

FIG. 7 a schematic view of an embodiment of the receiver arrangement, wherein the spout comprises a flexible tube,

FIG. 8 a schematic view of a custom ear tip coupled to the flexible tube.

Corresponding parts are marked with the same reference symbols in all figures.

### DETAILED DESCRIPTION

Described herein are a receiver module and a receiver arrangement.

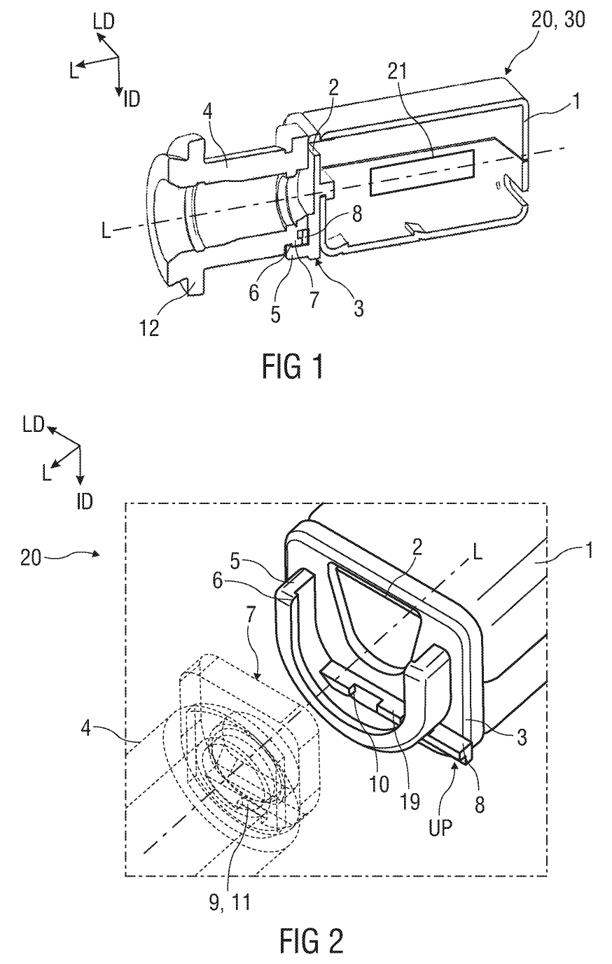

FIG. 1 is a schematic view of a receiver arrangement 30, comprising a receiver module 20, e.g. for a receiver in canal hearing device (RIC) or an in the ear hearing device (ITE). The receiver module 20 comprises a housing 1, e.g. an elongate housing 1, configured to be inserted into an ear canal of a user and contains a speaker 21, e.g. a balanced armature speaker, configured to reproduce sound through a sound port 2 at an end of the housing 1 in a longitudinal direction L into the ear canal. The other end of the housing 1 in the longitudinal direction L may be connected to a behind the ear part of the hearing device through a cable.

The end of the housing 1 having the sound port 2 comprises an adapter 3 or is formed as an adapter 3 configured to releasably couple to a spout 4 (speaker out).

The adapter 3 may be part of the housing 1 or be connected to the housing 1, e.g. by gluing.

The receiver arrangement 30 comprises the receiver module 20 and the spout 4.

FIG. 2 is another view of the embodiment of the receiver module 20 of FIG. 1. The adapter 3 comprises a holding structure 5 having a shoulder 6 allowing insertion of a complementary structure 7 of the spout 4 in an insertion direction ID transverse or perpendicular to the longitudinal direction L into the holding structure 5 so that the complementary structure 7 engages the holding structure 5 behind the shoulder 6 which keeps the spout 4 from being removed from the adapter 3 in the longitudinal direction L. The complementary structure 7 may be essentially plate shaped.

The holding structure 5 and the complementary structure 7 may comprise a semi-elliptical, in particular a semi-circular cross section. In other embodiments, the cross sections of the holding structure 5 and the complementary structure 7 may be different from semi-circular.

Moreover, the adapter 3 may comprise a locking bar 8 movable in a locking direction LD which may be transverse or perpendicular to both the longitudinal direction L and the insertion direction ID within the holding structure 5, in particular arranged opposite a side of the holding structure 5 from which the complementary structure 7 is inserted into the holding structure 5. The complementary structure 7 of the spout 4 comprises a locking structure 9 configured to be adjacent the locking bar 8 when the complementary structure 7 is fully inserted in the holding structure 5.

In FIG. 2, the locking bar 8 is shown in an unlocked position UP, in which the complementary structure 7 may be inserted into the holding structure 5 or removed from the holding structure 5 in the insertion direction ID or in the opposite direction, respectively.

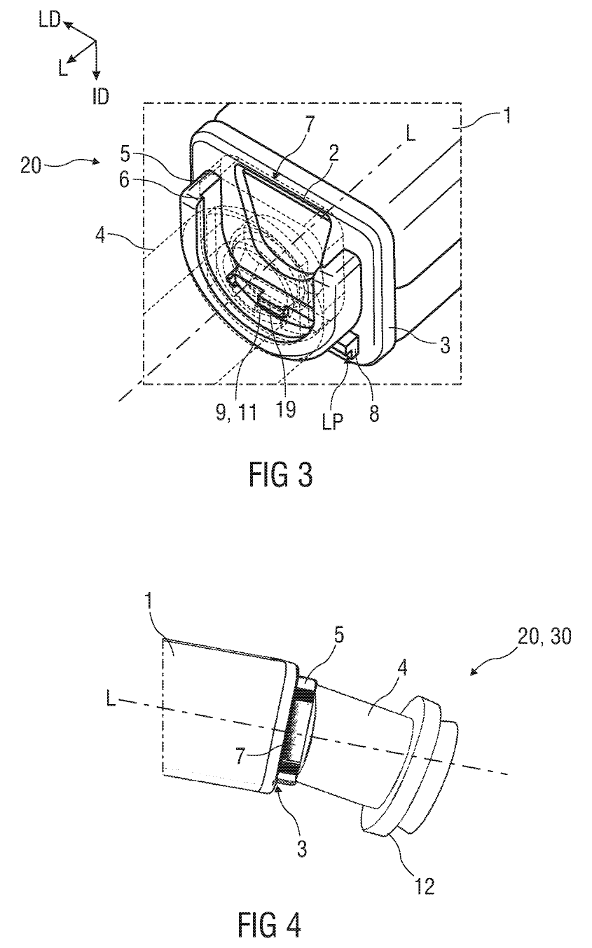

FIG. 3 is a schematic view of the embodiment of the receiver module 20 of FIG. 1, wherein the complementary structure 7 of the spout 4 has been inserted into the holding structure 5 in the insertion direction ID so that the complementary structure 7 engages the holding structure 5 behind the shoulder 6 which keeps the spout 4 from being removed from the adapter 3 in the longitudinal direction L. Furthermore, the locking bar 8 has been moved from the unlocked position UP into a locked position LP, in which the locking bar 8 engages the locking structure 9 in such a way that the complementary structure 7 is locked in position preventing it from being moved out of the holding structure 5 in the insertion direction ID or in the opposite direction.

The locking bar 8 may comprise a recess 10 which, in the unlocked position UP, allows a protrusion 11 on the locking structure 9 to pass. When the locking bar 8 is moved into the locked position LP, a protrusion 19 on the locking bar 8 engages the protrusion 11 on the locking structure 9 preventing the complementary structure 7 from being moved out of the holding structure 5 in the insertion direction ID or in the opposite direction.

In FIG. 1, the spout 4 is at least essentially straight and comprises a circumferential shoulder 12 for engaging a dome (not shown).

FIG. 4 is a schematic view of an embodiment of the receiver arrangement 30 comprising a receiver module 20 similar to the one of FIGS. 1 to 3, however with the spout 4 being angled with respect to the longitudinal direction L.

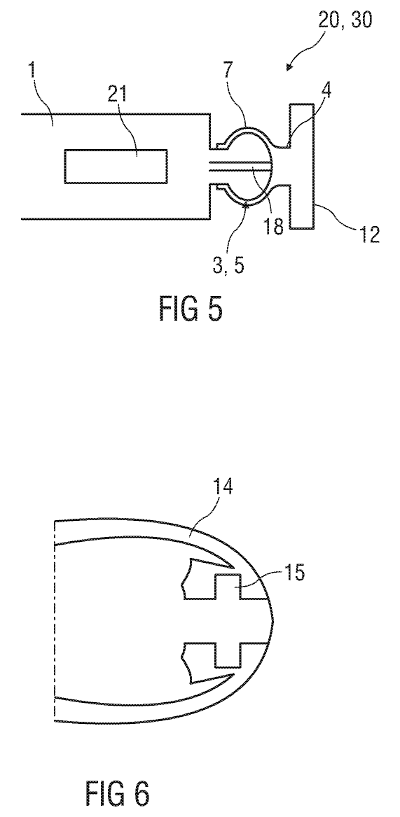

FIG. 5 is a schematic view of another embodiment of a receiver arrangement 30 comprising a receiver module 20. In this embodiment, the adapter 3 comprises a holding structure 5 shaped as a spherical or spheroid head. The spout 4 has a complementary structure 7 which is shaped complementary to the spherical or spheroid head of the holding structure 5 on the inside and slightly larger than the holding structure 5 to allow the holding structure 5 to be frictionally engaged in the complementary structure 7.

The holding structure 5 and/or the complementary structure 7 may have one or more longitudinal slots 18 respectively, so as to allow the holding structure 5 to be collapsed to some extent and/or the complementary structure 7 to be expanded to some extent such that the complementary structure 7 can snap onto the holding structure 5.

In other embodiments, the complementary structure 7 on the spout 4 is shaped as a spherical or spheroid head and the adapter 3 has a holding structure 5 which is shaped complementary to the spherical or spheroid head of the complementary structure 7 on the inside and slightly larger than the complementary structure 7 to allow the complementary structure 7 to be frictionally engaged in the holding structure 5. The holding structure 5 may be slightly smaller than the complementary structure 7 to allow the holding structure 5 to be frictionally engaged in the complementary structure 7.

The adapter 3 and/or the spout 4 may consist of or comprise a metal or a plastic.

FIG. 6 is a schematic view of a dome 14 configured to seal against the ear canal of the user. The dome comprises an internal circumferential notch 15 configured to engage the circumferential shoulder 12 on the spout 4.

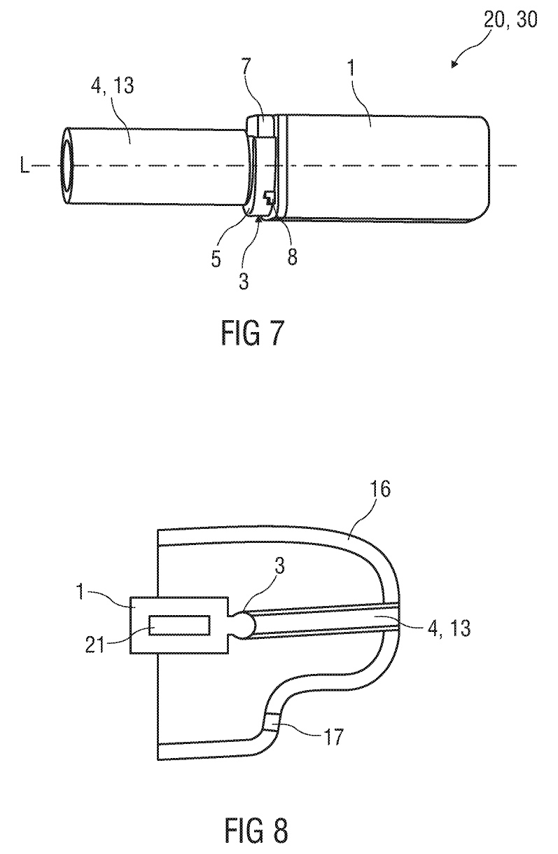

FIG. 7 is a schematic view of an embodiment of a receiver arrangement 30 comprising a receiver module 20, wherein the spout 4 comprises a flexible tube 13 attached at one end to the complementary structure 7. In other embodiments, the complementary structure 7 may be part of the flexible tube 13.

FIG. 8 is a schematic view of a custom ear tip 16 coupled to another end of the flexible tube 13. The flexible tube 13 allows the custom ear tip 16 to be tilted to adapt to the shape of the ear canal, e.g. at a bend thereof. The ear tip 16 may have a vent opening 17.

The adapter 3 allows for replacing the spout 4 by a different one, e.g. having a different size and/or shape. The solution according to the embodiments described herein may improve adjustment of the receiver 20 to fit the anatomy of the user’s ear canal, keep the diameter of the coupling between the housing 1 and the spout 4 small. Moreover, the retention of the receiver 20 in the ear canal may be improved, e.g. by the dome 14 or custom ear piece 16 being allowed to tilt relative to the longitudinal axis L of the receiver and engage behind a bend in the ear canal, in particular if the ear canal tapers. The solution according to the embodiments described herein may also improve or facilitate the centering of the dome 14 or custom ear piece 16 in the ear canal to improve sealing and/or reduce irritation and thus improve wearing comfort. Moreover, the pickup of cerumen may be reduced.

### List of References

1 housing
2 sound port
3 adapter
4 spout
5 holding structure
6 shoulder
7 complementary structure
8 locking bar
9 locking structure
10 recess
11 protrusion
12 shoulder
13 tube
14 dome
15 notch
16 ear tip
17 vent opening
19 protrusion
20 receiver module
21 speaker
30 receiver arrangement ID insertion direction L longitudinal direction LD locking direction LP locked position UP unlocked position

18 slot

What is claimed is:

1. A receiver module configured to be inserted into an ear canal of a user, the receiver module comprising a housing containing a speaker configured to reproduce sound into the ear canal through a sound port arranged at an end of the housing in a longitudinal direction, the end of the housing having the sound port comprising an adapter or being formed as an adapter configured to releasably couple to a spout.

2. The receiver module according to claim 1, wherein the adapter is part of the housing or fixed to the housing.

3. The receiver module according to claim 2, wherein the adapter is fixed to the housing by gluing.

4. A receiver arrangement comprising the receiver module according to claim 1 and a spout, wherein the adapter comprises a holding structure and the spout comprises a complementary structure configured to engage with the holding structure.

5. The receiver arrangement of claim 4, wherein the holding structure has a shoulder allowing insertion of the complementary structure of the spout in an insertion direction transverse or perpendicular to the longitudinal direction into the holding structure so that the complementary structure engages the holding structure behind the shoulder preventing the spout from being removed from the adapter in the longitudinal direction.

6. The receiver arrangement according to claim 5, wherein the holding structure and the complementary structure comprise a semi-elliptical, in particular semi-circular cross section.

7. The receiver arrangement according to claim 5, wherein the adapter comprises a locking bar movable in a locking direction transverse or perpendicular to both the longitudinal direction and the insertion direction within the holding structure, between an unlocked position allowing insertion and removal of the complementary structure and a locked position, in which the locking bar engages the locking structure in such a way that the complementary structure is prevented from being removed from the holding structure.

8. The receiver arrangement according to claim 4, wherein the spout comprises a circumferential shoulder for engaging an internal circumferential notch in a dome configured to seal against the ear canal.

9. The receiver arrangement according to claim 4, wherein the spout is at least essentially straight or angled with respect to the longitudinal direction when attached to the housing.

10. The receiver arrangement according to claim 4, wherein the holding structure is shaped as a spherical or spheroid head, wherein the complementary structure is shaped complementary to the spherical or spheroid head of the holding structure on the inside and slightly larger than the holding structure to allow the holding structure to engage in the complementary structure by friction and/or by a snap fit and/or by a threaded engagement.

11. The receiver arrangement according to claim 4, wherein the complementary structure is shaped as a spherical or spheroid head, wherein the holding structure is shaped complementary to the spherical or spheroid head of the complementary structure on the inside and slightly larger than the complementary structure to allow the complementary structure to engage in the holding structure by friction and/or by a snap fit and/or by a threaded engagement.

12. The receiver arrangement according to claim 10, wherein the holding structure and/or the complementary structure have/has one or more longitudinal slots respectively, so as to allow the holding structure and/or the complementary structure to be collapsed or expanded to some extent.

13. The receiver arrangement according to claim 4, wherein the adapter and/or the spout consist/consists of or comprise/comprises a metal and/or a plastic.

14. The receiver arrangement according to claim 4, wherein the spout comprises a flexible tube attached at one end to the complementary structure or comprising the complementary structure at one end.

15. The receiver arrangement according to claim 14, wherein the flexible tube at its other end is configured to be coupled to an ear tip.
